(19) United States
(12) Patent Application Publication
(10) Pub. No.: US 2011/0163110 A1
(43) Pub. Date: Jul. 7, 2011

(54) APPARATUS AND METHOD FOR IMPROVING DISPENSING OF REMOVABLE ADHESIVE TABS USING AN ADHESIVE LAYER FOR ADHERING A DISPENSER TO AN OBJECT

(76) Inventor: Harry V. Lehmann, Novato, CA (US)

(21) Appl. No.: 12/985,199

(22) Filed: Jan. 5, 2011

Related U.S. Application Data
(60) Provisional application No. 61/292,429, filed on Jan. 5, 2010.

(51) Int. Cl. B65D 83/08; F16B 47/00; B65H 1/04

(52) U.S. Cl. 221/1; 221/45; 248/205.3

(57) ABSTRACT

An improvement to a dispenser of pressure-sensitive notes or marking flags includes the addition of an adhesive layer and a backing layer to protect the adhesive layer. The adhesive layer allows the temporary adhesion of the dispenser to books, desks, folders or other devices in which such notes or flags are applied by the user, resulting in increase convenience.

### CROSS REFERENCES

This application is a non-provisional of and claims priority of co pending provisional application U.S. application Ser. No. 61/292,429 entitled Dispenser of Removable Adhesive Tabs which Dispenser is itself removably adherent filed Jan. 5, 2010 and claims priority thereof.

### BACKGROUND

There is a rich but decisive history in stationary note pads having movable adhesive characteristic. The first decisive prior art was U.S. Pat. No. 5,194,299, Inventor: Arthur C. Fry; Assignee: Minnesota Mining and Manufacturing Co., (hereafter 3M); the now celebrated work of Fry in applying certain removable adhesive technology which 3M had developed, particularly work which had been accomplished by Mr. Fry's 3M colleague Dr. Spencer Silver. The Fry-Silver accomplishment, supported by a 3M program which encouraged invention, is one of the most famous stories of invention of the late 20th Century, which resulting in the now-ubiquitous Post It Notes line of products, including Post It Flags, as commonly used by academic researchers, of great use to those who wish to readily preserve a position in volume, and yet feel an obligation to assure that no damage accrues to the book involved. The Fry patent, U.S. Pat. No. 5,194,299, as filed on Dec. 21, 1986, cited 25 earlier patents relating to removable adhesives, ranging in year from January of 1934 until July of 1984.

The Fry patent was distinguishable from the prior art in many sophisticated respects both with regard to adhesive content and as to means of application. It is not necessary for this Application to reference these differentiating characteristics but the pioneering work of Fry and Silver of 3M is background to the currently filed method and device.

Accepted generic terms for competitors include “sticky notes”, “positionable notes” and “repositionable notes.” 3M® manufactures other products related to the Post it® Brand note concept, leveraging the success of the brand; FIGS. 1 a, 1 b, and 1 c, while representative of both generic and Post It® varieties of the document flag concept, closely resemble the particular packaging motif used in the 3M® iteration. These are transparent plastic flags. The Application here made is with regard to all varieties of repositionable stationary notes, including paper, plastic, and other materials suitable to the trade.

The 3M® Post It® product line was the exclusive source of the product until patent expiration; today, several generic substitutes products are available as sold by several companies; nationally and internationally, but the 3M line still has a dominant position in the market, and high quality. Academic researchers in many fields use repositionable notes and flags as a means of tracking documentary content. However, while such flags are convenient, they are not handy, meaning often not readily accessible. The small, light, plastic flag containers are readily separated from the book, for one example, in which the subject research is being conducted, and time is lost while the researcher locates the container, or a replacement. The numeric use of the flags is decreased by their absence, and increased by their immediacy. Additionally, the use of such flags often require the use of two hands to extract the individual flags or notes.

It is therefore an object of the disclosed subject matter to present a novel method and apparatus that allows the temporary adhesion of the dispenser of notes or marking flags to books, desks, walls or other objects.

These and many other objects and advantages of the present subject matter will be readily apparent to one skilled in the art to which the invention pertains from a perusal of the claims, the appended drawings, and the following detailed description of preferred embodiments.

### BRIEF DESCRIPTION OF THE DRAWINGS

FIGS. 1A-1B illustrates a top and side view of a prior art dispenser of flags.

FIG. 1C illustrates a side view of a dispenser as shown in FIG. 1B with the improvement of adhesive layer as described in an embodiment of the disclosed subject matter.

FIG. 2 illustrates a dispenser of note pads with an adhesive layer as described in an embodiment of the disclosed subject matter.

### DETAIL DESCRIPTION

The disclosed method and apparatus allows the temporary adhesion of the dispenser to books, desks, walls, or other objects and makes an already successful product more handy and usable, meaning constantly available to the user. The use of the terms notes, flags, sheets, tabs, tape are intended to be ubiquitous and the use of one term is not intended to exclude others of the terms. In addition the object or surfaces to which the dispensers are intended to attach to are not limited to books, desks or walls, as other surfaces are also contemplated.

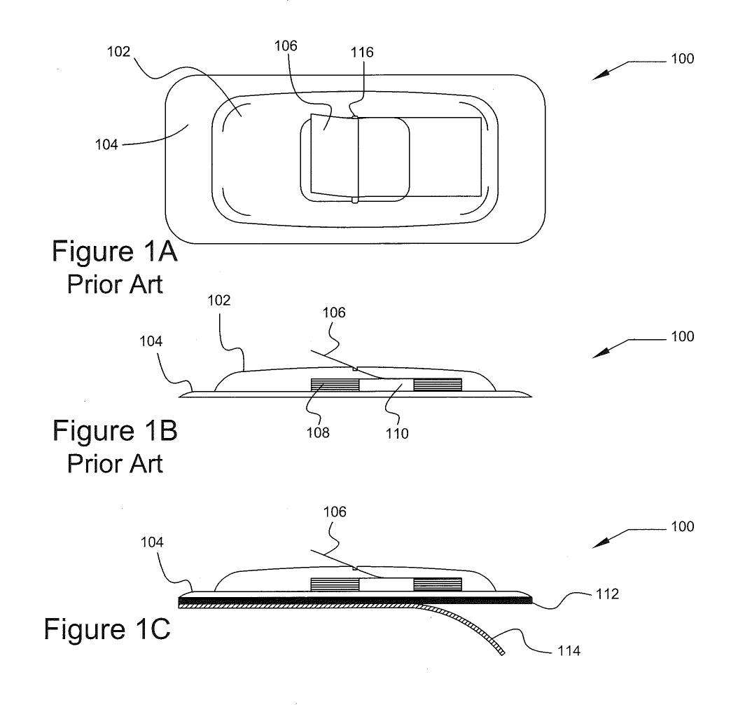

A dispenser 100 of transparent document flags are illustrated in FIGS. 1A, 1B, and 1C. A support or plate 104 supports a dispensing structure 102 for dispensing sheets 106 through slit 116, the structure 102 as shown is the transparent housing for the stored tags. A plurality of sheets (flags)) 106 are shown in an alternating stack where an adhesive backed section 110 attaches each of the flags 106 to the next flag. To remove the flags 106, tension is applied to the exposed end of the flag 106 with results in the flag being removed and the end of a subsequent flag being exposed. In the specific illustrations shown, each flag 106 has a head 108 which is typically colored. In the alternating state the heads alternation left and right as shown in FIG. 1B. The tension or pull required to remove the first flag from the dispenser and expose the subsequent flag is referred to hereinafter as the first tension. FIGS. 1A and 1B are illustrations of currently available prior art in this area and do not contain novelty.

FIG. 1C shows two new elements of Art, and illustrates the improvement of adding an adhesive layer 112 and a backing layer 114. The adhesive layer 112 is affixed to the bottom portion of the plate 104 opposite the structure 102. The adhesive layer is covered with a backing layer 114 to prevent unintentional adhesion and to protect the adhesive layer 112 when not adhered to a surface.

Preferably the adhesive layer is a low tack adhesive so that the entire dispenser 100 may be adhered to a book-in-progress, or other work under study, such as to the interior front or rear cover, and that then, upon completion, the dispenser 100 may be removed. To effectuate a seal on the low tack, by which reference is meant to include gel applications, the adhesive layer 112 may be protected by pull-away strip of glue-impervious material, or reinforced paper as one alternative as the backing layer 114.

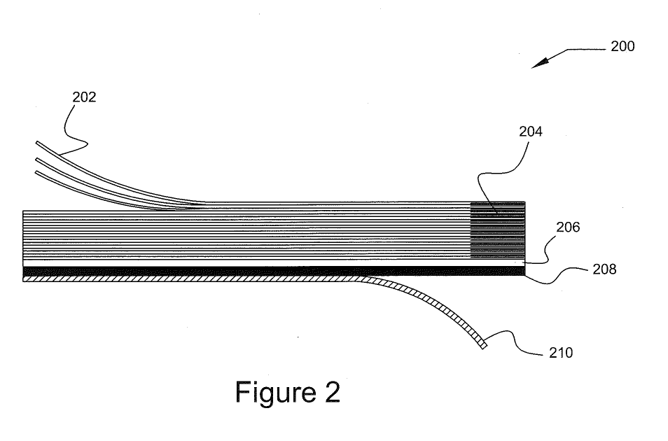

FIG. 2 shows an improvement to the traditional paper repositionable stationary notes, such as the Post It product line of notes, of particular practical application to the smaller squares or rectangles of same, which are also, like the flags, often used in the course of academic research according to an embodiment of the disclosed subject matter. The dispenser 200 includes a stack of repositionable notes 202 which are connected to each other with adhesive 204 on a plate 206. An adhesive layer 208 is adhered to the plate 206 and protected by backing layer 210. In FIG. 2, the repositionable notes 202 in contrast to the sheets of FIGS. 1A-1C are not stacked in an alternating manner. Again as described above with respect to FIG. 1C, the adhesive layer 208 allows temporary adhesion to book or other work surface. The cumulative effect of the features of the improvement as set forth above is to dramatically increase the convenience of use of such repositionable notes and flags. Personal use has shown that when the flags are thus made convenient and easier to access, they are more frequently deployed.

An aspect of the disclosed subject matter is that the adhesive may be one of many commercial available adhesive and pressure sensitive adhesives such as those described in U.S. Pat. Nos. 4,644,026 or 5,194,299, the contents thereof are incorporated herein by reference. The backing layer may also be a glue impervious material such as waxed or reinforced paper. It is an aspect that the adhesive layer provides instantaneous or near instantaneous adhesion to any surface it is in contact with yet remains tacky when reapplied to another surface. The adhesive used on the flags or pads may also be the same or different then the adhesive in the adhesive layer.

Another aspect of the disclosed subject matter is that the adhesive layer may include multiple layers such as a first permanent adhesive adhering the adhesive layer to the plate and a second adhesive layer for adhering to a surface. The first permanent adhesive layer need not be repositionable and thus may be fully or partially cured, whereas the second adhesive layer advantageously remains tacky as to allow for repositioning. Thus the first permanent adhesive may have a higher cure rate than the second adhesive layer.

Still another aspect of the disclosed subject matter is that the adhesive layer adhesion and area are selected such that it resists being pulled off the attached surface when subjected to the first tension as required to remove the individual flags. The area of the adhesive layer may advantageously be greater than that of the area of adhesive on the individual flags.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed:

1. An apparatus for dispensing a plurality of adhesive backed sheets one sheet at a time, wherein said plurality of adhesive backed sheets are stacked and removable attached to one another via an adhesive and pulled from the apparatus with the application of a first tension by a user to an upper one of the plurality of adhesive backed sheets, said apparatus comprising:
a plate upon which the plurality of sheets rest, said plate having a top side in proximity of the plurality of sheets and a bottom side oppositely disposed from the top side;
an adhesive layer having a first and second side the first side disposed on the bottom side of the plate; and,
a backing layer disposed on the second side of the adhesive layer,
wherein the backing layer is removable from the second side of the adhesive layer, said second side of the adhesive layer capable of adhering to a surface under a second tension greater than the first tension.

2. The apparatus of claim 1, wherein the adhesive layer comprises a first permanent adhesive adhering the layer to the bottom side of the plate and a second adhesive layer for adhering to a surface.

3. The apparatus of claim 1, wherein the adhesive layer is a low tack adhesive.

4. The apparatus of claim 3 wherein an area of the adhesive layer is greater that an area of adhesive of one of the plurality of sheets.

5. The apparatus of claim 4, wherein the adhesive layer and the adhesive are the same material.

6. The apparatus of claim 5, wherein the plate is paper stock.

7. The apparatus of claim 2, wherein the first permanent adhesive layer has a higher cure rate than the second adhesive layer.

8. The apparatus of claim 1, wherein the backing layer is impervious to the adhesive layer.

9. The apparatus of claim 1, wherein the backing layer has a tab to facilitate removal from the adhesive layer.

10. The apparatus of claim 1, wherein the plurality of sheets are stacked in an alternating fashion.

11. The apparatus of claim 1, wherein the plurality of sheets are stacked in a non alternating fashion.

12. A method of supplying adhesive backed sheets, comprising:
providing a dispenser containing a plurality of adhesive backed sheets with alternating orientations;
disposing a portion of one of the plurality of adhesive backed sheets through an opening on one side of the dispenser by which the plurality of adhesive backed sheets are dispensed;
providing to a back side of the dispenser an adhesive layer;
providing a removable backing layer on the adhesive layer opposite the back side of the dispenser;
removing the removable backing layer;
attaching the dispenser to an object by contacting the adhesive layer to a surface of the object and applying pressure; and,
applying tension to one of the plurality of adhesive back sheets to thereby remove from the dispenser, wherein the adhesion of the adhesive layer is sufficient to resist the applied tension.

13. The method of claim 12, wherein the adhesive layer comprises a first permanent adhesive adhering the layer to the back side of the dispenser and a second adhesive layer for adhering to the surface.

14. The method of claim 12, wherein the adhesive layer is a low tack adhesive.

15. The method of claim 14 wherein an area of the adhesive layer is greater that an area of adhesive of one of the plurality of sheets.

16. The method of claim 13, wherein the first permanent adhesive layer has a higher cure rate than the second adhesive layer.

17. The method of claim 12, wherein the backing layer is impervious to the adhesive layer.

18. The method of claim 12, wherein the backing layer has a tab to facilitate removal from the adhesive layer.

19. A device for dispensing a plurality of adhesive backed sheets, one sheet at a time, wherein said plurality of adhesively backed sheets are stacked and removable attached to one another via an adhesive and pulled from the apparatus with the application of a first tension by a user to an upper one of the plurality of adhesive backed sheets, said apparatus comprising:
a card stock plate upon which the plurality of sheets rest, said plate having a top side in proximity of the plurality of sheets with a transparent structure for dispensing the sheets and a bottom side oppositely disposed from the top side;
an adhesive layer having a first and second side the first side disposed on the bottom side of the plate; and,
a book adhered to the second side of the adhesives layer, wherein the adhesive layer adhering the card stock plate and book together at a second tension greater than the first tension.
